(19) United States
(12) Patent Application Publication
(10) Pub. No.: US 2023/0261208 A1
(43) Pub. Date: Aug. 17, 2023

(54) METHOD AND SYSTEM FOR PRODUCING ELECTROCHEMICAL CELLS, AND ELECTRODE FOR AN ELECTROCHEMICAL CELL

(71) Applicant: VARTA Microbattery GmbH, Ellwangen Jagst (DE)

(72) Inventors: Klaus Schoebel, Ellwangen (DE); Philipp Renschler, Ellwangen (DE); David Ensling, Ellwangen (DE); Martin Elmer, Ellwangen (DE)

(21) Appl. No.: 18/009,779

(22) PCT Filed: Jul. 1, 2021
(86) PCT No.: PCT/EP2021/068195

§ 371 Date: Dec. 12, 2022

(30) Foreign Application Priority Data
Jul. 1, 2020 (EP) 20183540.2

(51) Int. Cl. H01M 4/75; H01M 4/04; H01M 4/139; G06K 19/06

(52) U.S. Cl. CPC H01M 4/75; H01M 4/0404; H01M 4/139; G06K 19/06037

(57) ABSTRACT

A method for producing a component of an electrochemical cell includes applying at least one layer of an electrode material to a strip-shaped current collector passing through a coating apparatus such that the current collector, after passing through the coating apparatus, comprises one or more coated strip-shaped sections oriented in a longitudinal direction and being coated with electrode material and one or more uncoated strip-shaped sections oriented in the longitudinal direction. The method further includes assigning a respective uncoated strip-shaped section of the one or more uncoated strip-shaped sections a machine-readable coding that identifies the respective uncoated strip-shaped section. The machine-readable coding is assigned in the form of through holes into the respective uncoated strip-shaped section, or the coding is applied onto the respective uncoated strip-shaped section.

### CROSS REFERENCE TO RELATED APPLICATIONS

This application is a U.S. National Phase application under 35 U.S.C. § 371 of International Application No. PCT/EP2021/068195, filed on Jul. 1, 2021, and claims benefit to European Patent Application No. EP 20183540.2, filed on Jul. 1, 2020. The International Application was published in German on Jan. 6, 2022 as WO 2022/003109 under PCT Article 21(2).

### FIELD

The disclosure relates to a method and a system for producing electrochemical cells capable of energy storage, and to an electrode for such an electrochemical cell.

### BACKGROUND

Electrochemical cells capable of energy storage are able to convert stored chemical energy into electrical energy through a redox reaction. They generally comprise a positive and a negative electrode, which are segregated from one another by a separator. On discharge, electrons are released at the negative electrode as a result of an oxidation process. This results in an electron current that can be drawn off by an external electrical consumer, for which the electrochemical cell serves as a supplier of energy. At the same time, an ion current corresponding to the electrode reaction occurs within the cell. This ion current crosses the separator and is made possible by an ion-conducting electrolyte.

If the discharge is reversible, meaning that there is the possibility of reversing the conversion of chemical energy into electrical energy that took place on discharge and hence of recharging the cell, the cell is said to be a secondary cell. The designation of the negative electrode as the anode and the designation of the positive electrode as the cathode, as is commonplace with secondary cells, refers to the discharge function of the electrochemical cell.

The widespread secondary lithium-ion cells are based on the use of lithium, which is able to migrate back and forth in the form of ions between the electrodes of the cell. A feature of lithium-ion cells is a high energy density.

The negative and positive electrodes of a lithium-ion cell are generally what are known as composite electrodes, which, in addition to electrochemically active components (more particularly components which are able reversibly to intercalate and deintercalate lithium ions), also comprise electrochemically inactive components (conducting agents, electrode binders, current collectors). In the production of a lithium-ion cell, the composite electrodes are combined with one or more separators to form an assembly. In this assembly, the electrodes and separators are joined to one another usually under pressure, optionally also by lamination or by adhesive bonding.

In many embodiments, the assembly has a planar design, allowing a plurality of assemblies to be stacked flatly on one another. Very frequently, however, the assembly is formed as a winding or processed into a winding. Generally speaking, irrespective of whether it is wound or not, the assembly comprises the sequence of positive electrode/separator/negative electrode. Assemblies are frequently produced as what are known as bicells with the possible sequences of negative electrode/separator/positive electrode/separator/negative electrode or positive electrode/separator/negative electrode/separator/positive electrode.

For the production of the composite electrodes, typically a flat layer of a pastelike electrode material, which as well as an electrode binder and optionally a conductor comprises an electrochemically active component (often also referred to as active material) in particle form, is applied to a suitable current collector and then dried. The electrode material is preferably applied to both sides of the current collector. In production terms, this is usually accomplished by providing the current collectors in the form of virtually continuous strips, which then pass through a coating apparatus in which, through intermittent coating, there is a distinct coating, interrupted at defined intervals in the running direction, of the current collector. The current collector strip emerging from the coating apparatus has, correspondingly, coated and uncoated sections in alternation in the running direction.

The current collector strip can then be separated by cutting up the strip in the uncoated sections. If required, the current collector strip can additionally be cut into strips. In this way it is possible to produce two or more individual electrodes from each of the coated sections.

After the electrodes thus produced have been processed to form assemblies, they are transferred into a housing. The basic functionality of the cell can then be established by impregnating the assembly with an electrolyte. The cell thus formed can then be subjected to a function and performance test.

Of pivotal importance for the quality of a cell is the absence of defects in the electrodes produced. The use of defective electrodes generally means that cells constructed therewith have to be located and removed as rejects.

### SUMMARY

In an embodiment, the present disclosure provides a method for producing a component of an electrochemical cell capable of energy storage, the electrochemical cell including a housing which encloses an interior and an assembly, disposed in the interior, which includes at least two electrodes and at least one separator. The method includes applying at least one layer of an electrode material to a strip-shaped current collector passing through a coating apparatus such that the current collector, after passing through the coating apparatus, comprises one or more coated strip-shaped sections oriented in a longitudinal direction and being coated with electrode material and one or more uncoated strip-shaped sections oriented in the longitudinal direction. The method further includes assigning a respective uncoated strip-shaped section of the one or more uncoated strip-shaped sections a machine-readable coding that identifies the respective uncoated strip-shaped section. The machine-readable coding is assigned in the form of through holes into the respective uncoated strip-shaped section, or the coding is applied onto the respective uncoated strip-shaped section.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of a current collector provided with a barcode and coated with a layer of an electrode material;

FIG. 2 shows a further embodiment of a current collector provided with a barcode and coated with a layer of an electrode material;

FIG. 3 shows an embodiment of a current collector provided with a plurality of individual codes and coated with a layer of an electrode material;

FIG. 4 shows a further embodiment of a current collector provided with a plurality of individual codes and coated with a layer of an electrode material;

FIG. 5 shows an embodiment of a cylindrical assembly on whose lateral surface a machine-readable code has been applied;

FIG. 6 shows a further embodiment of a cylindrical assembly on whose lateral surface a machine-readable code has been applied;

FIG. 7 shows a current collector which has an edge-positioned, uncoated, strip-shaped and coded section oriented in a longitudinal direction;

FIG. 8 shows a current collector which has an edge-positioned, uncoated, strip-shaped and coded section oriented in a longitudinal direction; and

FIG. 9 shows a current collector which has a coded, uncoated, strip-shaped section oriented in a longitudinal direction between two coated strip-shaped sections oriented in the longitudinal direction.

### DETAILED DESCRIPTION

It would be desirable to be able to, as early as possible, detect any defects and tolerance deviations occurring, at least for the most relevant components of an electrochemical cell, and ideally to be able to locate and remove, as quickly as possible, those components that are defective or outside of a tolerance. This would require traceability of the components in the production chain and, of course, a corresponding possibility of unambiguous identification. Individual components of electrochemical cells can currently be assigned at best to batches.

The present disclosure provides for the production of electrochemical cells, capable of energy storage, having an assembly which is formed of at least two electrodes and at least one separator. More preferably, the cells to be produced comprise a housing which encloses an interior and is composed preferably of two or more housing parts, and the assembly disposed in the interior and formed of the at least two electrodes and the at least one separator.

In accordance with a first aspect, the disclosure, provides a method for the production of electrochemical cells in which a machine-readable coding, more particularly a barcode and/or a 2D code, is applied to the assembly or to at least one constituent of the assembly, or optionally to at least one of the housing parts or to another component of the cell to be produced, for example a seal, or is introduced into a component of the assembly. This affords diverse advantages:

The individual components of an electrochemical cell are traceable possibly as far as the individual constituents of the assembly.

Within a system for producing the electrochemical cells, it is possible, owing to the individual marking, to tell at any time where, for example, an individual electrode is located within a production process.

In the testing of cells, it is possible to produce possible correlations between production parameters and the function or the performance values of the completed cells.

A machine-readable coding refers both to an individual machine-readable code, namely, for example, an individual barcode or an individual 2D code, and to a plurality of machine-readable codes, namely, for example, a plurality of 2D codes in a row.

In the assembly, the electrodes are disposed in the sequence of positive electrode/separator/negative electrode.

The electrochemical cells to be produced are preferably secondary lithium-ion cells having the aforementioned composite electrodes composed of current collectors coated with electrode materials.

Active materials used for anode and cathode of the cells can be basically all electrochemically active components known for secondary lithium-ion cells.

In the negative electrode, active materials used may be carbon-based particles such as graphitic carbon or nongraphitic carbon materials capable of intercalating lithium, these materials being preferably likewise in particle form. Furthermore, metallic and semimetallic materials that can be alloyed with lithium may also be employed. For example, the elements tin, aluminum, antimony and silicon are capable of forming intermetallic phases with lithium. Some compounds of silicon, aluminum, tin and/or antimony as well are able to incorporate and release lithium reversibly. In some preferred embodiments, for example, the silicon may be present in oxidic form in the negative electrode. Alternatively or additionally, lithium titanate (Li₄Ti₅O₁₂) or a derivative thereof may also be present in the negative electrode, preferably likewise in particle form.

For the positive electrode, candidate active materials include, for example, lithium-metal oxide compounds and lithium-metal phosphate compounds such as LiCoO₂ and LiFePO₄. Additionally highly suitable are, in particular, lithium nickel manganese cobalt oxide (NMC) having the molecular formula LiNiₓMn_{y}Co_{z}O₂ (where x+y+z is typically 1), lithium manganese spinel (LMO) having the molecular formula LiMn₂O₄, or lithium nickel cobalt aluminum oxide (NCA) having the molecular formula LiNiₓCo_{y}Al_{z}O₂ (where x+y+z is typically 1). Derivatives thereof as well, for example lithium nickel manganese cobalt aluminum oxide (NMCA) with the molecular formula Li_{1.11}(Ni_{0.40}Mn_{0.39}Co_{0.16}Al_{0.05})_{0.89}O₂ or Li₁₊ₓM—O compounds and/or mixtures of the stated materials, can be used.

The active materials are preferably embedded into a matrix composed of an electrode binder, with adjacent particles in the matrix being preferably in direct contact with one another. Customary electrode binders are based, for example, on polyvinylidene fluoride (PVDF), polyacrylate or carboxymethylcellulose.

Conducting agents may additionally be added to the electrodes. Conducting agents serve to increase the electrical conductivity of the electrodes. Customary conducting agents are carbon black and metal powders.

In the completed cell, the assembly is preferably impregnated with an electrolyte, preferably an electrolyte based on at least one lithium salt such as, for example, lithium hexafluorophosphate (LiPF₆), which is present in solution in an organic solvent (e.g. in a mixture of organic carbonates or in a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The current collectors serve for electrical contact, over as large an area as possible, between electrochemically active components present in the electrode material. The current collectors preferably consist of a metal or at least are surface-metallized. Suitability as metal for the anode current collector is possessed, for example, by copper or nickel or else other electrically conductive materials, more particularly alloys of copper and of nickel, or nickel-coated metals. Stainless steel is a candidate in principle as well. Suitability as metal for the cathode current collector is possessed, for example, by aluminum or else other electrically conductive materials, including, in particular, aluminum alloys.

The anode current collector and/or the cathode current collector preferably in each case uses metal foils, having a thickness, for example, in the range from 4 μm to 30 μm.

As well as foils, the current collectors used may, however, also be other substrates such as metallic or metallized nonwovens or open-pore foams or expanded metals.

The separator used may be, for example, an electrically insulating plastic film. So that it can be penetrated by the electrolyte, it preferably comprises micropores. The film may be formed, for example, of a polyolefin or of a polyetherketone. The possibility of also using nonwovens and wovens composed of such plastic materials or similar plastic materials, as separators, is not ruled out.

The electrochemical cell to be produced, more particularly the lithium-ion cell to be produced, may be a button cell. Button cells are of cylindrical design and have a height which is smaller than their diameter. The height of the button cell to be produced is preferably in the range from 4 mm to 15 mm. It is preferable, furthermore, for the button cell to be produced to have a diameter in the range from 5 mm to 25 mm. Button cells are suitable, for example, for supplying small electronic devices such as watches, hearing aids and wireless headphones with electrical energy.

The nominal capacity of a lithium-ion cell produced by the method and taking the form of a button cell is generally up to 1500 mAh. The nominal capacity is preferably in the range from 100 mAh to 1000 mAh, more preferably in the range from 100 to 800 mAh.

The electrochemical cell can be produced, more particularly the lithium-ion cell to be produced, is more preferably a cylindrical round cell. Cylindrical round cells have a height which is greater than their diameter. They are especially suitable for applications in the automotive sector, for e-bikes or else for other applications with high energy demand.

The height of cylindrical round cells to be produced is preferably in the range from 15 mm to 150 mm. The diameter of the cylindrical round cells is preferably in the range from 10 mm to 60 mm. Within these ranges, particular preference is given to form factors of, for example, 18×65 (diameter times height in mm) or 21×70 (diameter times height in mm). Cylindrical round cells having these form factors are especially suitable for supplying power to electrical drives of motor vehicles.

The nominal capacity of a lithium-ion-based cylindrical round cell produced by the method is preferably up to 90 000 mAh. With the form factor of 21×70, the cell, embodied as a lithium-ion cell, preferably has a nominal capacity in the range from 1500 mAh to 7000 mAh, more preferably in the range from 3000 to 5500 mAh. With the form factor of 18×65, the cell, embodied as a lithium-ion cell, preferably has a nominal capacity in the range from 1000 mAh to 5000 mAh, more preferably in the range from 2000 to 4000 mAh.

In the European Union, manufacturer specifications in relation to data concerning the nominal capacities of secondary batteries are strictly regulated. For instance, data on the nominal capacity of secondary nickel-cadmium batteries must be based on measurements in accordance with standards IEC/EN 61951-1 and IEC/EN 60622, data on the nominal capacity of secondary nickel-metal hydride batteries must be based on measurements in accordance with standard IEC/EN 61951-2, data on the nominal capacity of secondary lithium batteries must be based on measurements in accordance with standard IEC/EN 61960, and data on the nominal capacity of secondary lead-acid batteries must be based on measurements in accordance with standard IEC/EN 61056-1. Any data on nominal capacities in the present application are preferably likewise based on these standards.

In all embodiments in which the cell to be produced is a button cell or a cylindrical round cell, the assembly disposed in the interior is of preferably cylindrical design, more particularly in the form of a cylindrical coil comprising spirally rolled electrode layers and separator layers. Correspondingly, it preferably has two terminal, substantially circular end faces and a running-round lateral surface.

The separators and current collectors that are needed in order to produce such an assembly are preferably of strip-shaped design and preferably have the following dimensions:
a length in the range from 0.3 m to 25 m, and
a width in the 30 mm to 145 mm range.

In the case of a cylindrical round cell having the form factor 18×65, the current collectors for example preferably have
a width of 56 mm to 62 mm, preferably of 60 mm, and
a length of not more than 1.5 m.

In the case of a cylindrical round cell having the form factor 21×70, the current collectors for example preferably have
a width of 56 mm to 68 mm, preferably of 65 mm, and
a length of not more than 2.5 m.

The housing of the button cell and of the round cells is preferably substantially cylindrical in design. In one preferred embodiment, the housing, for example, has a cup-shaped first housing part with a base and a running-round sidewall and an opening, and a second housing part which closes the opening. In numerous further preferred embodiments, the housing parts are electrically insulated from one another by a plastic seal.

The assemblies to be produced may in principle also be disposed in a prismatic housing, more particularly in the stacked form mentioned earlier. In these embodiments, the housing is not encompassed by an electrochemical cell. Instead it preferably runs round a multiplicity of assemblies.

If the housing is prismatic in design, then the housing as a general rule encompasses a plurality of rectangular sidewalls, and also a polygonal, more particularly rectangular, top part and a polygonal, more particularly rectangular, bottom part. It is preferably composed of a first and a second housing part, the first housing part preferably encompassing the sidewalls and the polygonal bottom part, while the second housing part corresponds preferably to the polygonal top part.

The method includes at least one of the directly following features a. to e.:
a. The assembly is cylindrical in design and comprises the two terminal, substantially circular end faces and the running-round lateral surface.
b. The machine-readable code is applied on the lateral surface.
c. The outside of the lateral surface is formed at least partly, preferably completely, by a separator winding and/or by an adhesive sheet.
d. The machine-readable coding comprises a barcode or is a barcode.
e. The bars of the code are circular bars which run round the lateral surface.

With particular preference, the features a., b., d. and e. immediately above are realized in combination.

The run round-applied coding enables automated readability during the processing of the assembly, from all sides.

A barcode may be more particularly a code which is laid down in one of the following international standards:
ISO/IEC 15420 (EAN, UPC, IAN, JAN commercial barcodes)
ISO/IEC 16390 (2/5 family code)
ISO/IEC 16388 (39 code)
ISO/IEC 15417 (128 code)

In certain embodiments, it is preferable to apply a code other than a barcode, for example a 2D code, to the assembly or to another component of the cell to be produced. Examples of candidate 2D codes include codes which are laid down in one of the following international standards:
ISO/IEC 18004 (QR code)
ISO/IEC 16022 (Data Matrix code)
ISO/IEC JTC1 SC31 (Han Xin code)
ISO/IEC 15417

In certain embodiments, the machine-readable code may also be a composite code, namely a code composed of a linear barcode and a 2D code.

In further embodiments, the code may also be a coding comprising alphanumeric characters, in other words, for example, a coding consisting of numbers, a coding consisting of letters, or a mixed coding, therefore comprising numbers and letters and also, optionally, special characters (for example, punctuation characters such as period and comma, plus and minus characters, parentheses, or letters with diacritical marks). The coding, of course, may also comprise characters from non-European languages, examples being Chinese, Japanese, Korean or Cyrillic characters.

In certain embodiments, it is also possible for the machine-readable coding to comprise a barcode or a 2D code or a composite code in combination with one or more alphanumeric characters or a sequence of alphanumeric characters.

Further constituents of the cell to be produced, which are provided preferably with the machine-readable coding, are the housing parts and also, optionally, the aforementioned seal which can be disposed between the housing parts.

In many cases it is preferable for the machine-readable coding to be applied directly to the assembly, to the at least one constituent of the assembly or to the at least one of the housing parts or one of the aforementioned other components of the cell to be produced. It may, however, also be preferable for the coding to be applied to at least one label, which is then applied, more particularly by adhesive bonding, to the assembly, to at least one of its constituents, or to another component of the cell.

In variants of the method, at least one of the electrodes of the assembly is provided with a machine-readable coding. More particularly, both the positive and the negative electrodes are provided with a machine-readable coding.

Hence, in one first variant, for the production of the electrodes of the electrochemical cells,
a. at least one layer of an electrode material is applied to a strip-shaped current collector passing through a coating apparatus,
b. the layer is applied intermittently, so that the current collector after passing through the coating apparatus is subdivisible in longitudinal direction into sections coated with electrode material and uncoated sections between them, and
c. the strip-shaped current collector coated with electrode material passes through at least one cutting apparatus, in which in longitudinal direction the coated and the uncoated sections and in transverse direction the uncoated sections are cut, so that successive sections coated with electrode material are dissociated from one another and each of the coated sections is separated in longitudinal direction into at least two subsections, where
d. each of the coated sections is assigned a machine-readable coding which identifies the respective section, and
e. the coding is applied to the strip-shaped current collector and/or to the electrode material applied thereon, or is introduced into the strip-shaped current collector, in such a way that after passing through the at least one cutting apparatus, the coding is retrievable on each of the subsections and enables assignability of the subsections to the coded section.

The subsections separated off correspond to the electrodes of the cells to be produced, and may optionally be directly further processed.

This first variant of the method enables electrodes after the cutting operation at each stage of the method to be assigned to a current collector strip, to a section on the current collector strip, and optionally to a track within the section.

With particular preference, the strip-shaped current collector is coated on both sides with a layer of the respective electrode material.

In one development of the first variant, the method includes at least one of the directly following features a. and b.:
a. The machine-readable coding comprises a barcode or is a barcode.
b. The coding, more particularly the barcode, comprises lines or consists of lines which are applied perpendicularly or obliquely to the principal extent direction of the strip-shaped current collector to the strip-shaped current collector and/or to the electrode material applied thereon.

With particular preference, the features a. and b. immediately above are realized in combination with one another.

For the variant the use of a barcode is accompanied by particular advantages. Hence the lines of the barcode can be divided up by a corresponding longitudinal cut in the principal extent direction of the strip-shaped current collector, without loss of information. One barcode, accordingly, after passage through the at least one cutting apparatus, can identify all subsections of a coated section.

It would be simpler to apply the lines of the barcode in the principal extent direction of the strip-shaped current collector. The advantages described, however, outweigh the difficulties which arise in the application of lines oriented perpendicularly or obliquely.

In the case of an oblique orientation of the lines of the barcode, these lines enclose an angle, with a longitudinal edge of the strip-shaped current collector, of preferably from 89.9° to 1°, more preferably from 89.9° to 25°, more particularly from 89.9° to 45°.

The layer of the electrode material is applied usually in the form of a rectangular or strip-shaped area to the current collector. The coated sections therefore preferably have a rectangular or strip-shaped geometry. In the variant, the lines of the barcode preferably have a length which corresponds to or exceeds the width of the coated area.

In an alternative development of the first variant, the method includes at least one of the immediately following features a. to c.:
a. The coding comprises a plurality of individual codes which are applied, offset from one another in transverse direction, to the strip-shaped current collector and/or to the electrode material applied thereon.
b. The number of individual codes per coated section corresponds to the number of subsections into which the section is separated.
c. The coding is a code from the group of barcode and 2D code.

With particular preference, the features a. to c. immediately above are realized in combination with one another.

In this development, the individual codes are preferably placed in such a way that their readability after passage through the at least one cutting apparatus is not adversely affected and that each of the subsections is identified with one of the individual codes. The identification of each subsection with an individual code has the advantage that, given appropriate information content of the code, it is also possible in principle to make a distinction between individual subsections of a section.

In this development it is preferable for the bars of a barcode to be oriented longitudinally to the principal extent direction of the strip-shaped current collector, and not perpendicularly or obliquely to said direction.

It is preferable for the first variant of the method to be further distinguished by the following additional feature a.:
a. The coding assigned to a coated section is applied to the current collector in at least one of the uncoated sections immediately bordering that section.

It is preferable to apply the coding after the application of the electrode material to the current collector. It is, though, entirely possible as well to apply the coding to the current collector even before passage through the coating apparatus. This may even be particularly advantageous—indeed, in this embodiment, the coding is also able to serve as a marking for a section to be coated and is therefore able to help control the intermittent coating of the current collector. The coating apparatus in this embodiment may be assigned a device for recognizing the applied code.

With particular preference, the coding is placed on the current collector, more particularly in the uncoated section, in such a way that when the uncoated section is cut in the transverse direction, the coding is not damaged.

In one simple case the coding of a section comprises a number whereby the section can be unambiguously identified. With particular preference, the sections are numbered serially.

If the coding is introduced into the strip-shaped current collector, the coding is preferably a succession of two or more holes in the current collector. Such holes may be cut into the current collector using a laser or else may be introduced into the current collector mechanically, for example by punching.

It is possible, for example, using two hole shapes which differ through a difference in geometry and/or in their size, to introduce a binary code into the current collector. In this case, one of the hole shapes stands for 0, the other for 1.

In one second variant for the production of the electrodes of the electrochemical cells, the method for producing electrochemical cells capable of energy storage includes the following features:
a. At least one layer of an electrode material, for example of one of the electrode materials described above, is applied to a strip-shaped current collector passing through a coating apparatus, where
b. the application of the at least one layer takes place in such a way that the current collector, after passing through the coating apparatus, comprises at least one strip-shaped section oriented in longitudinal direction and coated with electrode material, and at least one uncoated strip-shaped section oriented in longitudinal direction,
c. the uncoated strip-shaped section or at least one of the uncoated strip-shaped sections is assigned a machine-readable coding which identifies the respective section, and
d. the coding is introduced in the form of through-holes into the uncoated strip-shaped section or into at least one of the uncoated strip-shaped sections, as has already been described, or the coding is applied to at least one of the uncoated strip-shaped sections, preferably likewise as has already been described above.

In one preferred embodiment, the application of the at least one layer takes place in such a way that the current collector, after passage through the coating apparatus, has an edge-positioned, uncoated, strip-shaped section oriented in longitudinal direction. In this case the coding is introduced into this uncoated section or applied to this uncoated section.

In another preferred embodiment, the application of the at least one layer takes place in such a way that the current collector, after passage through the coating apparatus, has an uncoated, strip-shaped section, oriented in longitudinal direction between two coated strip-shaped sections oriented in longitudinal direction. In this case the coding is preferably introduced into this uncoated section or applied to this uncoated section.

In a development of the second variant, the method is notable for the immediately following feature e.:
e. The strip-shaped current collector coated with electrode material passes through at least one cutting apparatus, in which the strip-shaped section coated with electrode material or at least one of the strip-shaped sections coated with electrode material and/or at least one uncoated strip-shaped section disposed between two strip-shaped sections coated with electrode material are or is cut in longitudinal direction.

If, for example, after passage through the coating apparatus, the current collector has an uncoated, strip-shaped section oriented in longitudinal direction between two coated strip-shaped sections oriented in longitudinal direction, then preferably the coding is introduced into this uncoated section or applied to this section, the uncoated section being subsequently cut. In that case the coding can be applied in such a way that, after passage through the at least one cutting apparatus, it is retrievable on each of the subsections resulting from the cutting.

It is further preferable for the first variant of the method or the second variant of the method to be notable for at least one of the immediately following additional features a. and b.:
a. The coding includes, optionally as well as the identification of the section, the result of at least one check to which the section has been subjected.
b. The coding includes, optionally as well as the identification of the section, information on the length and/or on the width of the section.

In the case of the check, the check may involve, for example, checking the thickness of the electrode coating.

An electrode produced in accordance with the variant of the method includes the following feature a.:
a. It comprises a machine-readable code which includes information which enables assignability of the electrode to a section, coated with electrode material, of a strip-shaped current collector from which the electrode has been fabricated.

Regarding preferred embodiments of the electrode, its individual constituents, the code and the positioning thereof, reference is made, in order to avoid repetition, to observations above. Irrespective thereof, however, it should be emphasized once again that the electrode with particular preference is notable for at least one of the immediately following features a. and b., more particularly for a combination of the immediately following features a. and b.:
a. The electrode is of strip-shaped design.
b. The coding, more particularly the barcode, comprises lines or consists of lines which are oriented perpendicularly or obliquely to the principal extent direction of the electrode.
c. The coding is the abovementioned succession of two or more holes in the current collector.

According to a second aspect, the disclosure provides a system suitable for implementing the method, more particularly a system suitable for implementing the first variant of the method. The system includes a combination of the following features:
a. It comprises a coating apparatus in which a layer of an electrode material is applied intermittently to a strip-shaped current collector passing through the coating apparatus.
b. It comprises at least one cutting apparatus which is designed to cut the strip-shaped current collector, coated with electrode material, in longitudinal direction and/or in transverse direction.
c. It comprises an apparatus for applying a machine-readable coding to the strip-shaped current collector and/or to the electrode material applied thereon, said apparatus being designed to apply lines perpendicularly or obliquely to the principal extent direction of the strip-shaped current collector and/or a plurality of individual codes offset from one another in transverse direction to the strip-shaped current collector and/or to the electrode material applied thereon.

The coating apparatus may for example comprise a nozzle as described in EP 2 775 771 B 1. The cutting apparatus may comprise mechanical means, for example a knife, and/or a laser for the purpose of dividing the current collector. The apparatus for applying the machine-readable coding may be a printer, for example.

If the coding is introduced into the strip-shaped current collector, more particularly in accordance with the second variant of the method, then the system preferably comprises, in place of the apparatus for applying a machine-readable coding, an apparatus for introducing the coding into the strip-shaped current collector. The apparatus for introducing the coding may be, for example, a punching system or a laser.

It is possible, furthermore, for the coding to be applied, more particularly adhered, in the form of a label. The apparatus for applying the machine-readable coding may therefore also be a labeling apparatus.

In certain preferred embodiments, the label may also be an RFID tag which comprises the machine-readable coding. The coding in this case can be read via radio.

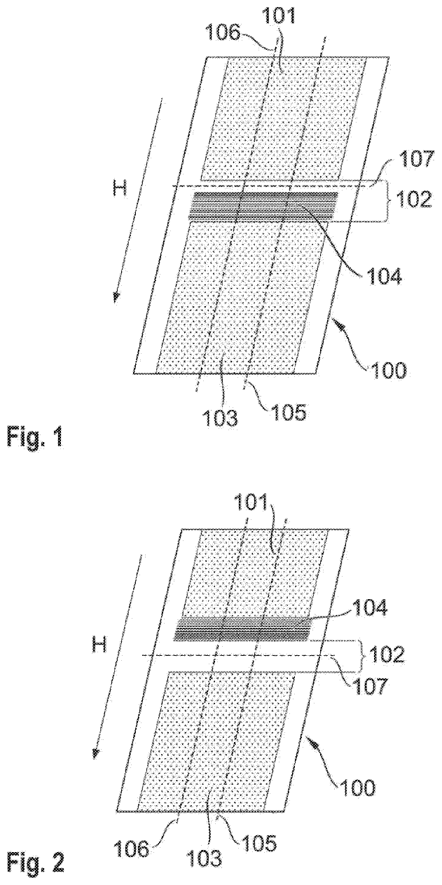

The current collector 100 represented in FIG. 1 comprises, in alternating order, sections 101 and 103 coated with electrode material, and uncoated sections 102. The current collector 100 is a strip-shaped metal foil. The electrode material is applied in the form of a thin layer on the current collector 100. The uncoated section 102 separates the two coated sections 101 and 103. In the uncoated section 102, a barcode 104 is applied directly on the current collector 100. The barcode 104 consists of lines which are oriented perpendicularly to the principal extent direction H of the current collector 101. The barcode 104 is assigned to the section 103, which it identifies. It transports a number assigned to the section 103.

In the case of two longitudinal cuts along the lines 105 and 106, aligned parallel to the principal extent direction H, through the current collector 100, the coated sections 101 and 103 are subdivided into three respective subsections. Each of the subsections resulting from the section 103 is identified, even after the longitudinal cutting, by the barcode 104, which is likewise cut during the longitudinal cuts.

A cross section through a region of the section 102 that is not provided with the barcode 104, along the line 107, separates the sections 101 and 103 from one another.

The current collector 100 represented in FIG. 2 comprises, in alternating order, sections 101 and 103 coated with electrode material, and uncoated sections 102. The current collector 100 is a strip-shaped metal foil. The electrode material is applied in the form of a thin layer on the current collector 100. The uncoated section 102 separates the two coated sections 101 and 103. In the uncoated section 101, a barcode 104 is applied directly on the electrode material. The barcode 104 consists of lines which are oriented perpendicularly to the principal extent direction H of the current collector 101. The barcode 104 is assigned to the section 101, which it identifies. It transports a number assigned to the section 101.

In the case of two longitudinal cuts along the lines 105 and 106, aligned parallel to the principal extent direction H, through the current collector 100, the coated sections 101 and 103 are subdivided into three respective subsections. Each of the subsections resulting from the section 101 is identified, even after the longitudinal cutting, by the barcode 104, which is likewise cut during the longitudinal cuts.

The resultant subsections cannot be distinguished from one another solely on the basis of the barcode. Provision may therefore be made for the application of numbers or characters to the current collector, in addition to the barcode, that enables differentiation of the subsections. Illustratively, the subsections resulting from the longitudinal cuts are each numbered in FIG. 2—see reference symbol 111. Here, the number in front of the hyphen could for example one the section 101. A supplementary identification of this kind would of course also be conceivable with the embodiment represented in FIG. 1.

A cross section through the section 102 along the line 107 separates the sections 101 and 103 from one another.

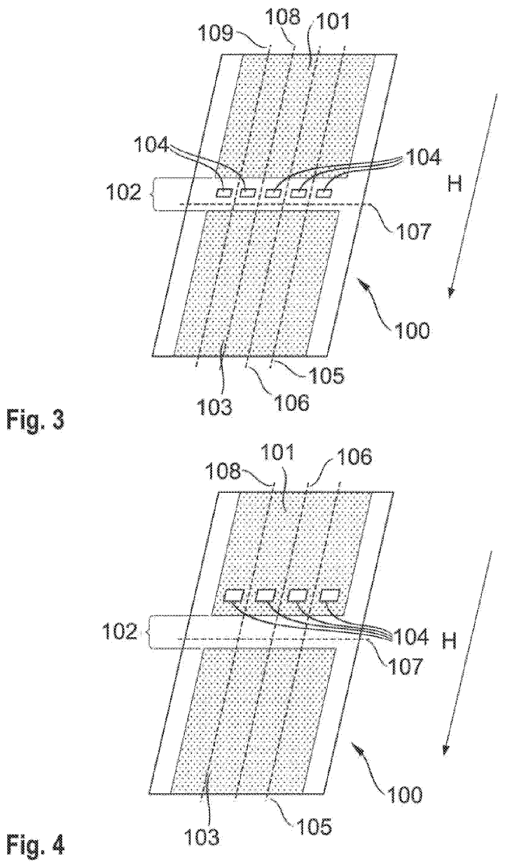

The current collector 100 represented in FIG. 3 comprises, in alternating order, sections 101 and 103 coated with electrode material, and uncoated sections 102. The current collector 100 is a strip-shaped metal foil. The electrode material is applied in the form of a thin layer on the current collector 100. The uncoated section 102 separates the two coated sections 101 and 103. In the uncoated section 102, a plurality of individual codes 104 are applied directly on the current collector 100. The individual codes 104 are in each case QR codes. They are assigned to the section 101, which they identify. Each of the individual codes 104 transports a number assigned to this section 101. Furthermore, each of the individual codes 104 transports a further individual number, which distinguishes it from all other individual codes 104 assigned to the section 101.

In the case of four longitudinal cuts along the lines 105, 106, 108 and 109, aligned parallel to the principal extent direction H of the current collector 101, through the current collector 100, the coated sections 101 and 103 are subdivided into five respective subsections. Each of the subsections resulting from the section 101 is identified, even after the longitudinal cutting, by one of the individual codes 104, and may be distinguished from other subsections by means of the further individual number.

A cross section through the section 102 along the line 107 separates the sections 101 and 103 from one another.

The current collector 100 represented in FIG. 4 comprises, in alternating order, sections 101 and 103 coated with electrode material, and uncoated sections 102. The current collector 100 is a strip-shaped metal foil. The electrode material is applied in the form of a thin layer on the current collector 100. The uncoated section 102 separates the two coated sections 101 and 103. In the coated section 101, a plurality of individual codes 104 are applied directly on the electrode material. The individual codes 104 are in each case QR codes. They are assigned to the section 101, which they identify. Each of the individual codes 104 transports a number assigned to this section 101. Furthermore, each of the individual codes 104 transports a further individual number, which distinguishes it from all other individual codes 104 assigned to the section 101.

In the case of three longitudinal cuts along the lines 105, 106 and 108, aligned parallel to the principal extent direction, through the current collector 100, the coated sections 101 and 103 are subdivided into four respective subsections. Each of the subsections resulting from the section 101 is identified, even after the longitudinal cutting, by one of the individual codes 104, and may be distinguished from other subsections by means of the further individual number.

A cross section through the section 102 along the line 107 separates the sections 101 and 103 from one another.

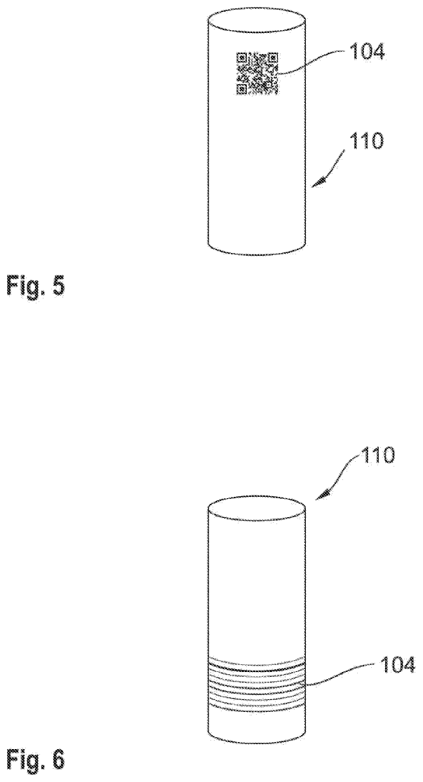

The cylindrical assembly 110 represented in FIG. 5 and formed from electrodes and separators by spiral winding is identified by a QR code 104. The QR code 104 is applied on the outside of the lateral surface of the assembly 110.

The outside of the lateral surface may be formed by an outer turn of one of the separators of the assembly 110 or by an adhesive sheet. The QR code 104 (or else a different machine-readable code) may be applied directly on the outside, in other words more particularly on the turn of the separator or on the adhesive sheet, for example by means of a printing process. Alternatively, the QR code 104 (or else a different machine-readable code) may also be located on a label which has been adhered to the outside.

It is also possible for the QR code 104 (or else a different machine-readable code) to be applied on an adhesive strip which is adhered on the outside of the lateral surface of the assembly 110 for the purpose of securing an external turn of the assembly 110 formed by winding, for example a turn of a separator strip. Or, in other words, an adhesive label with a QR code applied thereon may be used for securing the coil.

The cylindrical assembly 110 represented in FIG. 6 is identified by a barcode 104. The barcode 104 is applied on the lateral surface of the assembly 110. The bars of the code are circular bars which run round the lateral surface.

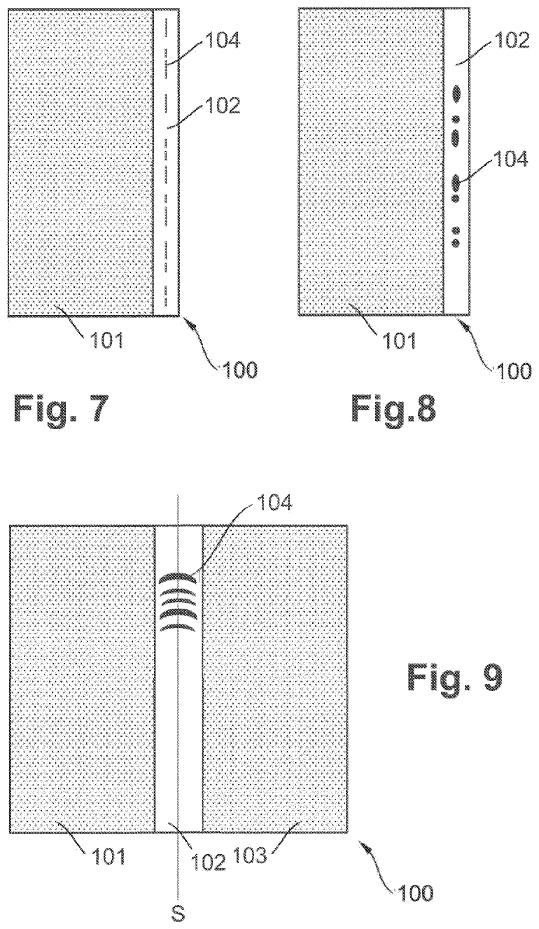

The current collector 100 represented in FIG. 7 has a strip-shaped section 101, oriented in longitudinal direction and coated with electrode material, and an edge-positioned, uncoated, strip-shaped section 102 oriented in longitudinal direction. Applied on the uncoated section 102 is a coding 104 in the form of elongate lines. The lines may represent, for example, a binary code, with the short lines standing for 0 and the long lines for 1 (or vice versa). Alternatively, instead of the lines, the coding may comprise elongate slot-shaped holes which have been made by means of a knife or by means of a laser, for example. This may have advantages in the context of the subsequent processing. As a general rule, the electrode material has to be calendered in the section 101. During that operation, it is also possible for the thickness of the current collector to change in this region, whereas the thickness of the current collector in the uncoated region 102 remains unaltered. This may lead to stresses in the current collector, resulting in deformation of the electrode obtained after calendering. It has now been observed that the introduction of through-holes into the uncoated region 102 in connection with the coding may have a stress-reducing effect. The coding in the uncoated edge region therefore fulfills a plurality of functions. It carries utilizable information, and it reduces stresses that occur from the calendering. The stress-reducing effect may be reinforced by introducing the slot-shaped holes in transverse direction or obliquely (and not in longitudinal direction, as shown).

The current collector 100 represented in FIG. 8 has a strip-shaped section 101, oriented in longitudinal direction and coated with electrode material, and an edge-positioned, uncoated, strip-shaped section 102 oriented in longitudinal direction. Introduced into the uncoated section 102 is a coding 104 in the form of round and elongate holes. The holes may represent, for example, a binary code, with the round holes standing for 0 and the elongate holes for 1 (or vice versa). The holes may also have a stress-reducing effect, like the slot-shaped holes in the case of FIG. 7.

The current collector 100 represented in FIG. 9 has an uncoated, strip-shaped section 102 oriented in longitudinal direction and between two coated strip-shaped sections 101 and 103 oriented in longitudinal direction. In this case as well there is a coding 104 introduced into this uncoated section 101. The coding 104 comprises half-moon-shaped indentations in two different sizes, which have been cut or punched into the section 102. The half-moon-shaped indentations may represent, for example, a binary code, with the smaller indentations standing for 0 and the larger indentations for 1 (or vice versa). Two strip-shaped electrodes can be obtained by means of a cut through the current collector along the line S in a cutting apparatus. Since in this case the half-moon-shaped indentations are parted symmetrically, their information is still retrievable even after the cutting.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1-8. (canceled)

9. A method for producing a component of an electrochemical cell capable of energy storage, the electrochemical cell including a housing which encloses an interior and an assembly, disposed in the interior, which includes at least two electrodes and at least one separator, the method comprising:
applying at least one layer of an electrode material to a strip-shaped current collector passing through a coating apparatus such that the current collector, after passing through the coating apparatus, comprises one or more coated strip-shaped sections oriented in a longitudinal direction and being coated with electrode material and one or more uncoated strip-shaped sections oriented in the longitudinal direction,
assigning a respective uncoated strip-shaped section of the one or more uncoated strip-shaped sections a machine-readable coding that identifies the respective uncoated strip-shaped section, wherein:
the machine-readable coding is assigned in the form of through holes into the respective uncoated strip-shaped section, or the coding is applied onto the respective uncoated strip-shaped section.

10. The method as claimed in claim 9, further comprising passing the strip-shaped current collector, after passing through the coating apparatus, through at least one parting apparatus to cut, in the longitudinal direction:
at least one of the one or more coated strip-shaped sections, and/or
at least one uncoated strip-shaped section disposed between two strip-shaped sections coated with electrode material.

11. The method as claimed in claim 9, wherein:
the coding includes, as well as an identification of the respective uncoated strip-shaped section, a result of at least one check to which the respective uncoated strip-shaped section has been subjected, and/or
the coding includes, as well as the identification of the respective uncoated strip-shaped section, information on a length and/or a width of the respective uncoated strip-shaped section.

12. The method as claimed in claim 9, wherein:
the coding includes, as well as an identification of the respective uncoated strip-shaped section, a result of at least one check to which the section has been subjected, wherein the check involves checking a thickness of the electrode coating.

13. A strip-shaped electrode produced by the method as claimed in claim 9, the electrode comprising:
a current collector including a respective one of the one or more coated strip-shaped sections oriented in the longitudinal direction and being coated with the electrode material, and the respective uncoated strip-shaped section.
